(19) United States
(12) Patent Application Publication
(10) Pub. No.: US 2015/0308597 A1
(43) Pub. Date: Oct. 29, 2015

(54) Swiveling Plumbing Fitting

(71) Applicant: Brad Lillmars, Cave Creek, AZ (US)

(72) Inventor: Brad Lillmars, Cave Creek, AZ (US)

(73) Assignee: Brad Lillmars, Cave Creek, AZ (US)

(21) Appl. No.: 14/696,273

(22) Filed: Apr. 24, 2015

Related U.S. Application Data
(60) Provisional application No. 61/983,731, filed on Apr. 24, 2014.

(51) Int. Cl. F16L 27/02; F16L 19/00

(52) U.S. Cl. CPC F16L 27/023; F16L 19/00

(57) ABSTRACT

A swivel fixture having a ball and socket configuration is provided. The swivel fixture allows for rotation, swiveling, and repositioning in multiple planes as dynamic pressure is applied through the swivel.

### CROSS REFERENCE TO RELATED APPLICATIONS

This application claims priority to U.S. Provisional Application Ser. No. 61/983,731, entitled “Swiveling Plumbing Fitting” filed Apr. 24, 2014, which is hereby incorporated by reference in its entirety.

### FIELD OF INVENTION

This disclosure relates generally to plumbing fittings and more specifically, to plumbing fittings capable of rotation in multiple planes.

### SUMMARY

In various embodiments, swiveling plumbing fixtures in accordance with the present disclosure may comprise an inlet portion and an outlet portion, a ball coupled to and in fluid communication with the inlet portion, and a socket coupled to and in fluid communication with the outlet portion, wherein the ball is located within the socket, wherein the ball comprises a ball inlet and a ball outlet, wherein the ball and socket permit the inlet portion to rotate as liquid flows through the inlet portion and outlet portion with respect to a longitudinal axis of the outlet portion, and wherein the ball and socket further comprise a liquid-proof seal as liquid flows through the inlet portion and outlet portion. The inlet portion may comprise a threaded portion and the outlet portion comprises a threaded portion. One or both of the inlet portion and outlet portion may comprise a quick disconnect fitting. The ball inlet or the socket inlet may be is in fluid communication with the inlet portion.

### BRIEF DESCRIPTION OF THE DRAWINGS

The present disclosure may be better understood with reference to the following drawing figures and description. Non-limiting and non-exhaustive descriptions are described with reference to the following drawing figures. The components in the figures are not necessarily to scale, emphasis instead being placed upon illustrating principles. In the figures, like referenced numerals may refer to like parts throughout the different figures unless otherwise specified.

FIG. 1 illustrates a side view of a plumbing fixture in accordance with the present disclosure; and

FIGS. 2A and 2B illustrate exploded views of plumbing fixtures in accordance with the present disclosure.

### DETAILED DESCRIPTION OF THE DRAWINGS

This disclosure describes devices and systems that are useful, for example, for improving flexibility and maneuverability of plumbing and irrigation systems. Several plumbing fixtures are described herein, and in general any of the features described with respect to a particular device may also be used with any of the other devices described herein. In some examples, one or more features described with respect to a particular device may be added to or included with another device. Also, various combinations or sub-combinations of any of the features described herein may generally be used with any of the devices described herein.

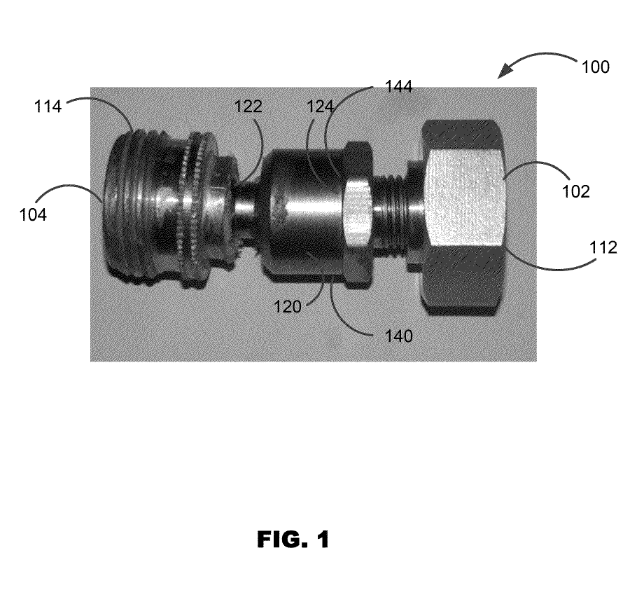

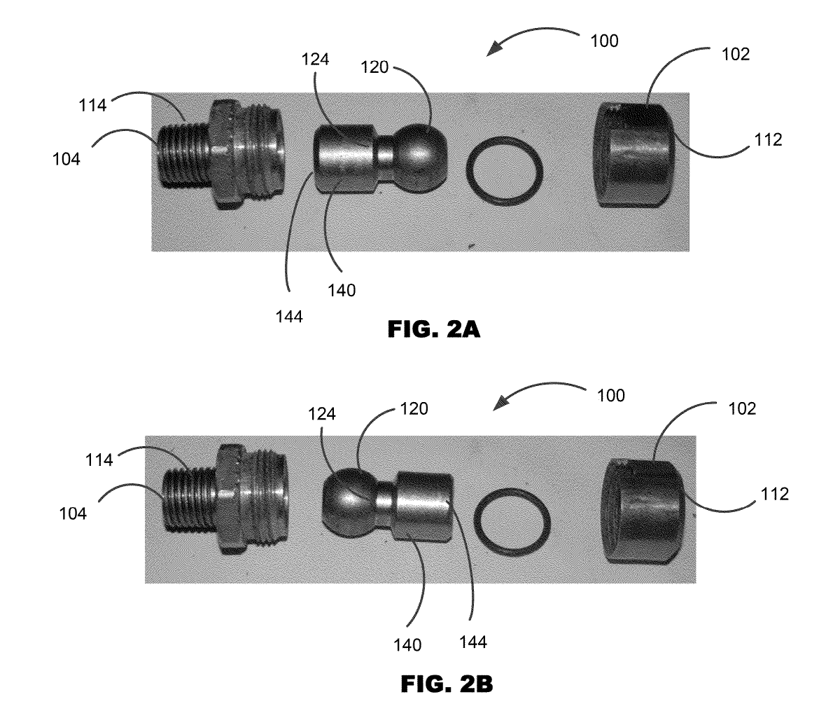

With initial reference to FIGS. 1, 2A, and 2B, an exemplary swivel fixture 100 is illustrated.

Swivel fixture 100 can comprise an inlet 102 portion and an outlet portion 104. In various embodiments, pressurized liquid such as water enters inlet portion 102 and exits outlet portion 104.

Swivel fixture 100 can comprise, for example, a metal material such as brass or stainless steel. In other embodiments, swivel fixture 100 can comprise a polymeric material. Although described with respect to specific materials, any material with suitable strength to operate under pressure provided by liquid flow is within the scope of the present disclosure.

In various embodiments, inlet portion 102 comprises a threaded portion 112 configured to receive and couple to a second plumbing fixture. Threaded portion 112 can comprise either a male or female configuration. For example, a male threaded portion 112 may be located on an outer surface of inner portion 102. In other embodiments, a female threaded portion 112 can be located on an outer surface of inner portion 102. Further, an exterior surface of inlet portion 102 can comprise a textured surface to allow for improved grip and easier manipulation of inlet portion 102. For example, the exterior surface of a portion of inlet 102 can be knurled.

In various embodiments, a second plumbing fixture can comprise a hose such as, for example, a garden hose. In such embodiments, the second plumbing fixture comprises a threaded portion that is complimentary to threaded portion 112 of inlet portion 102, such that the second plumbing fixture can be coupled to threaded portion 112 by screwing the two together.

Inlet portion 102 can, for example, be integrated into a second plumbing fixture. For example, a second plumbing fixture may have inlet portion 102 integrated into one end. In various embodiments, inlet portion 102 can be integral to the end of a hose, such as a garden hose.

In other embodiments, inlet portion 102 can comprise a quick disconnect fitting. In such embodiments, the second plumbing fixture can comprise a quick disconnect fitting that is complimentary to the fitting of inlet portion 102. Although described as particular exemplary embodiments (e.g., threaded portion 112, a quick disconnect portion), any structure suitable for coupling inlet portion 102 in a permanent or temporary manner with a second plumbing fixture is within the scope of the present disclosure.

Outlet portion 104 can comprise, for example, a threaded portion 114 configured to receive and couple to a third plumbing fixture. Similarly to threaded portion 112 of inlet portion 102, threaded portion 114 can comprise either a male or female configuration. In various embodiments, threaded portion 112 and threaded portion 114 comprise male configurations. In other embodiments, threaded portion 112 and threaded portion 114 comprise female configurations. In yet other embodiments, threaded portion 112 and threaded portion 114 comprise different configurations from each other. Similarly to inlet portion 102, an exterior surface of outlet portion 104 can comprise a textured surface to allow for improved grip and easier manipulation of outlet portion 104. For example, the exterior surface of a portion of outlet 104 can be knurled.

In various embodiments, a third plumbing fixture can comprise a hose, such as, for example, a garden hose. In such embodiments, swivel fixture 100 can permit second plumbing fixture and third plumbing fixture to swivel relative to each other while liquid is flowing between the two fixtures. In other embodiments, a third plumbing fixture can comprise a sprayer or nozzle. In such embodiments, the combined outlet 104 and third plumbing fixture can be coupled to a second plumbing fixture, such as a hose, which can permit the sprayer or nozzle to swivel relative to the hose while liquid is flowing between the two fixtures. Further, any third plumbing fixture capable of coupling to outlet portion 104 of swivel fixture 100 is within the scope of the present disclosure.

Similarly to a second plumbing fixture, a third plumbing fixture can comprise a threaded portion that is complimentary to threaded portion 114 of inlet portion 102, such that the second plumbing fixture can be coupled to threaded portion 114 by screwing the two together.

Outlet portion 104 can, for example, be integrated into a third plumbing fixture. For example, a third plumbing fixture may have outlet portion 104 integrated into one end. In various embodiments, outlet portion 104 can be integral to the end of a sprayer or nozzle.

Outlet portion 104 can comprise a quick disconnect fitting. In such embodiments, the third plumbing fixture can comprise a quick disconnect fitting that is complimentary to the fitting of outlet portion 104. Although described as particular embodiments (e.g., threaded portion 114, a quick disconnect portion), any structure suitable for coupling outlet portion 104 in a permanent or temporary manner with a third plumbing fixture is within the scope of the present disclosure.

In various embodiments, swivel fixture 100 comprises a ball 120 coupled to and in fluid communication with inlet portion 102. Ball 120 can comprise, for example a hollow spherical shape having a ball inlet 122 and a ball outlet 124. In various embodiments, ball 120 comprises a ball inlet 122 that is in fluid communication with inlet portion 102. As liquid flows through inlet portion 102, it enters the hollow spherical shape of ball 120 through ball inlet 122.

Swivel fixture 100 can further comprise, for example, a socket 140 coupled to and in fluid communication with outlet portion 104. In various embodiments, socket 140 comprises a circular shape that is complimentary to the shape of the outer surface of ball 120.

In various embodiments, at least a portion of ball 120 is surrounded by socket 140. Socket 140 can comprise a socket outlet 144. In such embodiments, liquid flowing through inlet 102 can enter ball 120, pass through ball outlet 124, and traverse socket outlet 144. In various embodiments, swivel fixture 100 further comprises a liquid proof seal between ball 120 and socket 140 such that, when liquid is flowing through swivel fixture 100, a substantial portion of the liquid is prevented from leaking out of swivel fixture 100. The liquid proof seal can be coupled to either ball 120 or socket 140.

Typically, swivel fixtures operate such that the fixture must be swiveled into a desired position before pressurized liquid flows through the fixture. As liquid flows through the fixture, the pressure “locks” the fixture into position, and it is difficult and/or not possible to change the position while the fixture is under such pressure. In various embodiments, ball 120 and socket 140 are configured to permit inlet portion 102 to rotate with regards to outlet portion 104 as liquid flows through swivel fixture 100.

Several characteristics and advantages have been set forth in the preceding description, including various alternatives together with details of the structure and function of the devices and/or systems. The disclosure is intended as illustrative only and as such is not intended to be exhaustive or limiting. It will be evident to those skilled in the art that various modifications may be made, especially in matters of structure, materials, elements, components, shapes, sizes, and arrangements of parts including combinations within the principles described herein, to the full extent indicated by the broad, general meaning of the terms in which the appended claims are expressed. To the extent that these various modifications depart from the spirit and scope of the appended claims, they are intended to be encompassed therein.

What is claimed is:

1. A plumbing fitting comprising:
an inlet portion and an outlet portion;
a ball coupled to and in fluid communication with the inlet portion; and
a socket coupled to and in fluid communication with the outlet portion,
wherein the ball is located within the socket,
wherein the ball comprises a ball inlet and a ball outlet, wherein the ball and the socket permit the inlet portion to rotate as liquid flows through the inlet portion and the outlet portion with respect to a longitudinal axis of the outlet portion, and
wherein the ball and the socket further comprise a liquid-proof seal as liquid flows through the inlet portion and the outlet portion.

2. The plumbing fitting of claim 1, wherein the inlet portion comprises a threaded portion and the outlet portion comprises a threaded portion.

3. The plumbing fitting of claim 1, wherein one of the inlet portion and the outlet portion comprises a quick disconnect fitting.

4. The plumbing fitting of claim 3, wherein the inlet portion comprises a quick disconnect fitting and the outlet portion comprises a quick disconnect fitting.
